(19) United States
(12) Patent Application Publication
(10) Pub. No.: US 2010/0218234 A1
(43) Pub. Date: Aug. 26, 2010

(54) METHOD AND APPARATUS FOR LIMITING OPERATION OF DIGITAL RIGHTS MANAGEMENT MODULE

(75) Inventors: Ki-hun LEE, Jeonju-si (KR); Chang-sup AHN, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/554,353

(22) Filed: Sep. 4, 2009

(30) Foreign Application Priority Data
Feb. 20, 2009 (KR) 10-2009-0014424

(51) Int. Cl. H04L 9/00

(52) U.S. Cl. 726/1

(57) ABSTRACT

A method and apparatus for limiting an operation of a digital rights management (DRM) module includes checking an operation mode that is currently set in the DRM module, deciding a DRM policy that will be applied to the DRM module, and selectively limiting an operation of the DRM module based on the checked operation mode and the decided DRM policy.

### CROSS-REFERENCE TO RELATED PATENT APPLICATION

This application claims the benefit of Korean Patent Application No. 10-2009-0014424, filed on Feb. 20, 2009, in the Korean Intellectual Property Office, the disclosure of which is incorporated herein in its entirety by reference.

### BACKGROUND OF THE INVENTION

1. Field of the Invention

The present invention relates to a method and apparatus for limiting an operation of a digital rights management (DRM) module.

2. Description of the Related Art

Digital rights management (DRM) refers to technologies and services for preventing illegal use of digital contents and protecting rights and profits of content providers. Currently, most digital contents are protected with DRM schemes before being distributed.

A DRM module is developed by a trusted authority, and maintains reliability by examining a digital signature after being downloaded.

In an open architecture environment, a third individual or party can manufacture the DRM module, in addition to the trusted authority, which makes it possible to achieve various implementations with regard to a DRM technology having the same standard. Although such an achievement can extend selection of end users, it may cause device malfunctions or allow illegal actions for malicious purposes or result in unintended mistakes by software developers.

### SUMMARY OF THE INVENTION

The present invention provides a method and apparatus for limiting an operation of a digital rights management (DRM) module.

According to an aspect of the present invention, there is provided a method of limiting an operation of a digital rights management (DRM) module in a device, the method including: checking an operation mode that is currently set in the DRM module; deciding a DRM policy that will be applied to the DRM module; and selectively limiting an operation of the DRM module based on the checked operation mode and the decided DRM policy.

The operation mode may be set as a default mode or, if the device receives an instruction to perform a predetermined operation, the operation mode is set as an operation mode corresponding to the received instruction.

The DRM policy may include information regarding a plurality of operations of the DRM module that are allowed to perform according to the operation mode that is currently set in the DRM module.

The selectively limiting of the operation of the DRM module may include: limiting the operation of the DRM module so that the DRM module does not perform an operation that is not allowed to perform in the operation mode that is currently set in the DRM module based on the decided DRM policy.

The method may further include: receiving at least one of the DRM module and the DRM policy, wherein the DRM module and the DRM policy are received all together or separately.

The deciding of the DRM policy that will be applied to the DRM module may include: if the DRM module and the DRM policy are received all together, deciding the DRM policy received with the DRM module as a DRM policy that will be applied to the DRM module.

The deciding of the DRM policy that will be applied to the DRM module may include: deciding the DRM policy that will be applied to the DRM module based on a type of the DRM module.

The selectively limiting of the operation of the DRM module may include: outputting a warning message indicating that the DRM module will perform an operation which is not allowed.

The checking of the operation mode, the deciding of the DRM policy, and the selectively limiting of the operation of the DRM module may be performed in a virtual machine.

According to another aspect of the present invention, there is provided an apparatus for limiting an operation of a DRM module in a device, the apparatus includes: an operation mode checking unit checking an operation mode that is currently set in the DRM module; a policy deciding unit deciding a DRM policy that will be applied to the DRM module; and an operation limiting unit selectively limiting an operation of the DRM module based on the checked operation mode and the decided DRM policy.

The apparatus may further include: a receiving unit receiving at least one of the DRM module and the DRM policy, wherein the receiving unit receives the DRM module and the DRM policy all together or separately.

According to another aspect of the present invention, there is provided a computer readable recording medium having recorded thereon a computer program for executing the method of limiting an operation of a DRM module in a device, the method includes: checking an operation mode that is currently set in the DRM module; deciding a DRM policy that will be applied to the DRM module; and selectively limiting an operation of the DRM module based on the checked operation mode and the decided DRM policy.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for limiting an operation of a digital rights management (DRM) module in a device according to an exemplary embodiment of the present invention;

FIG. 2 is a block diagram of an apparatus for limiting an operation of a DRM module in a device according to another exemplary embodiment of the present invention;

FIG. 3 is a diagram of a DRM policy according to an exemplary embodiment of the present invention; and

FIG. 4 is a flowchart of a method of limiting an operation of a DRM module in a device according to an exemplary embodiment of the present invention.

### DETAILED DESCRIPTION OF THE EXEMPLARY EMBODIMENTS

Hereinafter, the present invention will be described in detail by explaining exemplary embodiments of the invention with reference to the attached drawings.

FIG. 1 is a block diagram of an apparatus 100 for limiting an operation of a digital rights management (DRM) module in a device according to an exemplary embodiment of the present invention. Referring to FIG. 1, the apparatus 100 for limiting the operation of the DRM module includes an operation mode checking unit 110, a policy deciding unit 120, and an operation limiting unit 130. In this regard, it is assumed that the apparatus 100 for limiting the operation of the DRM module is installed in the device.

The operation mode checking unit 110 checks an operation mode that is currently set in the DRM module.

In this regard, the DRM module may be set in a default mode.

For example, if the device in which the DRM module is installed is a device for reproducing content, a decryption operation mode in which an operation of decrypting encrypted content is performed may be decided as the default mode, and may be set in the DRM module as the default mode.

Also, if the device in which the DRM module is installed is a device for encrypting the content, an encryption operation mode in which an operation of encrypting the content is performed may be decided as the default mode, and may be set in the DRM module as the default mode.

According to another embodiment, the default mode may be an operation mode in which the DRM module is set to perform no operation.

If the device receives an instruction to perform a predetermined operation, an operation mode corresponding to the received instruction may be set in the DRM module.

For example, if the device receives an instruction to reproduce the content, the decryption operation mode in which the operation of decrypting the encrypted content is performed may be set in the DRM module.

The policy deciding unit 120 decides a DRM policy that will be applied to the DRM module.

In this regard, the policy deciding unit 120 may decide the DRM policy that will be applied to the DRM module based on a type of the DRM module.

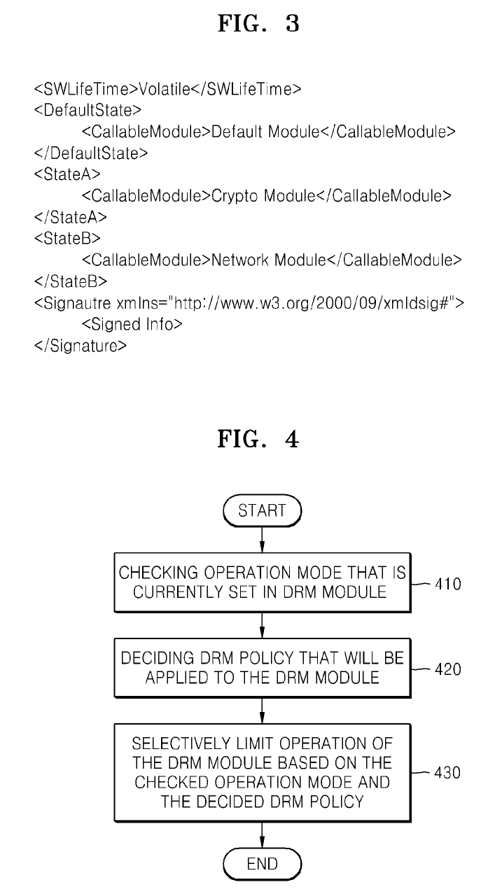

The DRM policy will be described in more detail with reference to FIG. 3 later.

The operation limiting unit 130 selectively limits an operation of the DRM module based on the operation mode of the DRM module checked by the operation mode checking unit 110 and the DRM policy decided by the policy deciding unit 120.

In more detail, the operation limiting unit 130 limits the operation of the DRM module so that the DRM module does not perform an operation that is not allowed in the operation mode that is currently set in the DRM module.

For example, when the operation mode that is currently set in the DRM module is the decryption operation mode in which the operation of decrypting the encrypted content is performed, if the DRM module performs the operation of decrypting the encrypted content, the operation limiting unit 130 does not limit the operation of the DRM module.

However, if the operation mode that is currently set in the DRM module is the decryption operation mode, and the DRM policy applied to the DRM module does not allow performing an operation of accessing a network in the decryption operation mode, the operation limiting unit 130 limits the operation of the DRM module that performs the operation of accessing the network.

In the present exemplary embodiment, the operation of the DRM module is selectively limited based on the operation mode that is currently set in the DRM module and the DRM policy applied to the DRM module, thereby preventing the DRM module from performing an improper action, for example, transmitting a decryption key used to decrypt the content to a third party over the network.

Although the DRM module and the DRM policy are installed in the device in the present exemplary embodiment, at least one of the DRM module and the DRM policy may be received from outside.

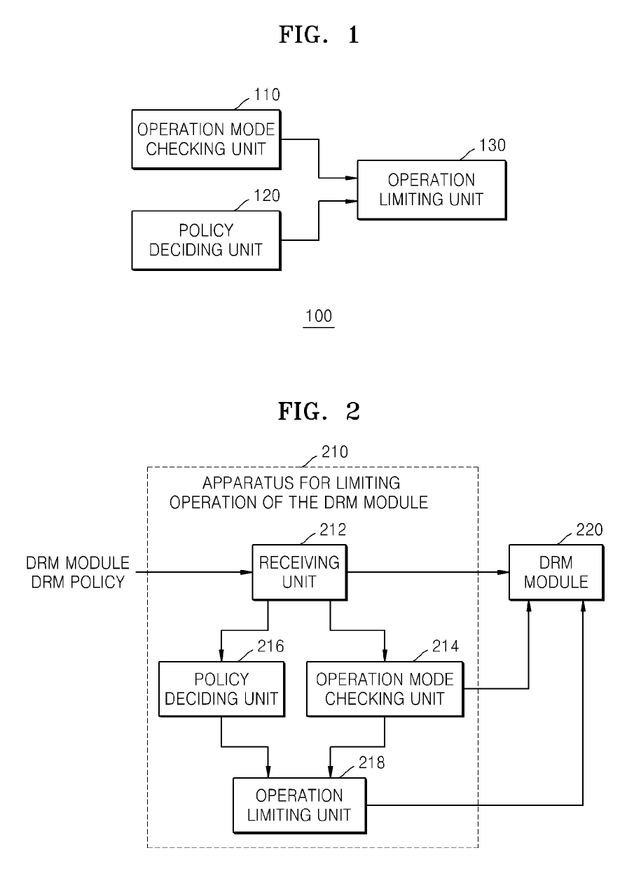

FIG. 2 is a block diagram of an apparatus 210 for limiting an operation of a DRM module 220 in a device according to another embodiment of the present invention. Referring to FIG. 2, the apparatus 210 for limiting the operation of the DRM module 220 includes a receiving unit 212, an operation mode checking unit 214, a policy deciding unit 216, and an operation limiting unit 218. For the descriptive convenience, the DRM module 220 is shown in FIG. 2.

In this regard, it is assumed that the apparatus 210 for limiting the operation of the DRM module 220 and the DRM module 220 are installed in the device.

The receiving unit 212 receives at least one of the DRM module 220 and a DRM policy.

The device may store the DRM module 220 and a DRM policy. In the present exemplary embodiment, the DRM module 220 is stored in the device.

The operation mode checking unit 214 checks an operation mode that is currently set in the DRM module 220 that is stored in the device.

If the operation mode checking unit 214 checks the operation mode that is currently set in the DRM module 220 after the DRM module 220 is received, a default mode may be set in the DRM module 220.

However, if the operation mode checking unit 214 checks the operation mode that is currently set in the DRM module 220 after the device receives a predetermined operation instruction, an operation mode corresponding to the predetermined operation instruction may be set in the DRM module 220.

The policy deciding unit 216 decides the DRM policy that will be applied to the DRM module 220 stored in the device.

If the receiving unit 212 receives the DRM module 220 and the DRM policy all together, the policy deciding unit 216 may decide the DRM policy as a DRM policy that will be applied to the DRM module 220 stored in the device.

However, according to another exemplary embodiment, the DRM policy may be decided based on a type of the DRM module, or the DRM policy that will be applied to the DRM module 220 stored in the device may be received from outside, as described above. If the DRM policy is not received from outside, the DRM module 220 may not operate.

The operation limiting unit 218 selectively limits the operation of the DRM module 220 based on the operation mode of the DRM module 220 checked by the operation mode checking unit 214 and the DRM policy decided by the policy deciding unit 216.

The operation limiting unit 218 may output a warning message indicating that the DRM module 220 will perform an operation that is not allowed before limiting the operation of the DRM module 220.

The apparatus 210 for limiting the operation of the DRM module 220 may be installed in a virtual machine and perform an operation in the present exemplary embodiment. Also, according to another exemplary embodiment, the apparatus 210 for limiting the operation of the DRM module 220 and the DRM module 220 may be installed in the virtual machine all together and perform an operation.

Also, although the device stores the DRM module 220 received by the receiving unit 212 in the present exemplary embodiment, the DRM module 220 may not be stored in the device and may be deleted after being used.

FIG. 3 is a diagram of a DRM policy according to an exemplary embodiment of the present invention. Referring to FIG. 3, the DRM policy is implemented in the format of extensible markup language (XML). However, the DRM policy may be generated in, for example, but not limited to, a structured text document or a binary file, in addition to the XML format, and the present exemplary invention is not limited thereto.

A tag <SWILife Time> indicates information regarding whether a DRM module is stored in a device or, if the DRM module is stored in the device, how long the DRM module is stored in the device.

In the present exemplary embodiment, since a value of the tag <SWILife Time> is “Volatile”, the tag <SWILife Time> indicates that the DRM module is not stored in the device. Thus, the DRM module to which the DRM policy is applied will be deleted immediately after being used.

According to another exemplary embodiment, the DRM policy may further include information regarding whether the DRM module is deleted partially or wholly when the DRM module is deleted, information regarding which part of the DRM module is deleted when the DRM module is partially deleted, information regarding whether the DRM module is encrypted and stored in the device, information regarding a encryption method that will be applied to the DRM module when the DRM module is encrypted, and the like.

Tags <DefalutState>, <StateA>, and <StateB> indicate operation modes of the DRM module, and indicate a default mode, an operation mode A, and an operation mode B, respectively. However, although a state of the DRM module may be used instead of the operation mode of the DRM module according to another exemplary embodiment, hereinafter, the state and the operation mode is unified into the operation mode.

A tag <CallableModule> indicates an operation that is allowed by the DRM module to perform according to the operation mode of the DRM module.

For example, in the operation mode A, an operation “Crypto Module” is allowed to be performed by the DRM module, which means that the DRM module is allowed to perform an encryption operation.

Also, in the operation mode B, an operation “Network Module” is allowed to be performed by the DRM module, which means that the DRM module is allowed to perform an operation related to a network.

Therefore, when the operation mode A is set in the DRM module in the present exemplary embodiment, the DRM module is allowed to perform a decryption operation and is not allowed to perform the operation related to a network.

A tag <Signature> indicates information relating to a digital signature verifying the DRM policy. A user verifies information regarding the digital signature executed in the DRM policy, thereby determining whether the DRM policy is reliable. As a result of the determination, if the DRM policy is determined to have been falsified, the DRM policy is not used.

The digital signature verifying the DRM policy may be executed by a trusted authority.

Although the DRM policy is prescribed to allow the DRM module to perform an operation in an operation mode in the present exemplary embodiment, according to another exemplary embodiment, the DRM policy may be prescribed to allow the DRM module to perform a plurality of operations in an operation mode.

For example, although the DRM module is allowed to perform the operation related to the network in the operation mode B in the present exemplary embodiment, the DRM module may be allowed to perform an encryption operation and an operation of accessing a file stored in the device in the operation mode B according to another exemplary embodiment.

FIG. 4 is a flowchart of a method of limiting an operation of a DRM module in a device according to an exemplary embodiment of the present invention. Referring to FIG. 4, in operation 410, an operation mode that is currently set in the DRM module is checked.

In operation 420, a DRM policy that will be applied to the DRM module is decided.

In this regard, at least one of the DRM module and the DRM policy may be received from outside.

In operation 430, an operation of the DRM module is selectively limited based on the checked operation mode and the decided DRM policy.

The exemplary embodiments of the present invention can be written as computer programs and can be implemented in general-use digital computers that execute the programs using a computer readable recording medium.

Examples of the computer readable recording medium include, but are not limited to, magnetic storage media (e.g., ROM, floppy disks, hard disks, etc.) and optical recording media (e.g., CD-ROMs, or DVDs). The exemplary embodiments of the present invention can also be embodied on computer readable transmission media such as carrier waves (e.g., transmission through the Internet).

While the present invention has been particularly shown and described with reference to exemplary embodiments thereof, it will be understood by one of ordinary in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of limiting an operation of a digital rights management (DRM) module in a device, the method comprising:
checking an operation mode that is currently set in the DRM module;
deciding a DRM policy that will be applied to the DRM module; and
selectively limiting an operation of the DRM module based on the checked operation mode and the decided DRM policy.

2. The method of claim 1, wherein the operation mode is set as a default mode or, if the device receives an instruction to perform a predetermined operation, the operation mode is set as an operation mode corresponding to the received instruction.

3. The method of claim 1, wherein the DRM policy comprises information regarding a plurality of operations of the DRM module that are allowed to be performed according to the operation mode that is currently set in the DRM module.

4. The method of claim 3, wherein the selectively limiting of the operation of the DRM module comprises limiting the operation of the DRM module so that the DRM module does not perform an operation that is not allowed to be performed in the operation mode that is currently set in the DRM module based on the decided DRM policy.

5. The method of claim 1, further comprising receiving at least one of the DRM module and the DRM policy,
wherein the DRM module and the DRM policy are received all together or separately.

6. The method of claim 5, wherein the deciding of the DRM policy that will be applied to the DRM module comprises, if the DRM module and the DRM policy are received all together, deciding the DRM policy received with the DRM module as a DRM policy that will be applied to the DRM module.

7. The method of claim 1, wherein the deciding of the DRM policy that will be applied to the DRM module comprises deciding the DRM policy that will be applied to the DRM module based on a type of the DRM module.

8. The method of claim 1, wherein the selectively limiting of the operation of the DRM module comprises outputting a warning message indicating that the DRM module will perform an operation which is not allowed.

9. The method of claim 1, wherein the checking of the operation mode, the deciding of the DRM policy, and the selectively limiting of the operation of the DRM module are performed in a virtual machine.

10. An apparatus for limiting an operation of a DRM module in a device, the apparatus comprising:
an operation mode checking unit which checks an operation mode that is currently set in the DRM module;
a policy deciding unit which decides a DRM policy that will be applied to the DRM module; and
an operation limiting unit which selectively limits an operation of the DRM module based on the checked operation mode and the decided DRM policy.

11. The apparatus of claim 10, wherein the operation mode is set as a default mode or, if the device receives an instruction to perform a predetermined operation, the operation mode is set as an operation mode corresponding to the received instruction.

12. The apparatus of claim 10, wherein the DRM policy comprises information regarding a plurality of operations of the DRM module that are allowed to be performed according to the operation mode that is currently set in the DRM module.

13. The apparatus of claim 12, wherein the operation limiting unit limits the operation of the DRM module so that the DRM module does not perform an operation that is not allowed to be performed in the operation mode that is currently set in the DRM module based on the decided DRM policy.

14. The apparatus of claim 10, further comprising: a receiving unit receiving at least one of the DRM module and the DRM policy,
wherein the receiving unit receives the DRM module and the DRM policy all together or separately.

15. The apparatus of claim 14, wherein the policy deciding unit, if the receiving unit receives the DRM module and the DRM policy all together, decides the DRM policy received with the DRM module as a DRM policy that will be applied to the DRM module.

16. The apparatus of claim 10, wherein the policy deciding unit decides the DRM policy that will be applied to the DRM module based on a type of the DRM module.

17. The apparatus of claim 10, wherein the operation limiting unit outputs a warning message indicating that the DRM module will perform an operation which is not allowed.

18. The apparatus of claim 10, wherein the operation mode checking unit, the DRM policy deciding unit, and the operation limiting unit are installed in a virtual machine.

19. The apparatus of claim 10, wherein the DRM policy further comprises a digital signature of a trusted authority verifying the DRM policy.

20. A computer readable recording medium having recorded thereon a computer program containing instructions for causing a computer to execute the method of claim 1.
